(19) United States
(12) Patent Application Publication
(10) Pub. No.: US 2024/0289544 A1
(43) Pub. Date: Aug. 29, 2024

(54) GRAPHICAL CELL CREATION PREVIEW BEFORE STRUCTURE UPDATE

(71) Applicant: MICROSOFT TECHNOLOGY LICENSING, LLC, Redmond, WA (US)

(72) Inventor: Christopher James WYMER, Valley View, OH (US)

(21) Appl. No.: 18/115,619

(22) Filed: Feb. 28, 2023

(51) Int. Cl. G06F 40/18

(52) U.S. Cl. CPC G06F 40/18

(57) ABSTRACT

The techniques disclosed herein enhance data entry programs by streamlining processes for the creation and formatting of cells. A data entry program can include a user interface comprising a grid of active cells that are formatted to store data such as a list or a spreadsheet. To create new cells a user can provide a hover input at a desired position relative to a position of an existing list. A set of inactive placeholder cells can then be generated in response to the hover gesture. The inactive placeholder cells can be displayed as a graphical preview alongside active cells which can be adjusted by moving the position of the hover input. The inactive placeholder cells can then be activated with a confirmation input and appended to the list as new active cells and accordingly formatted. In this way, a user can create and format new cells with a single input.

### BACKGROUND

As computing becomes ever more integrated into modern workplaces, many organizations equip workers with productivity suites to enable viewing, editing, and storage of information. These productivity suites can include several programs or applications that enable users to produce documents, multimedia files, and other digital items from one main platform. Productivity suites can also enable the user to share data among the various programs and with other users through online collaboration and remote file storage. Typically, productivity suites can be accessed via computing devices such as a desktop computer or a laptop computer. In addition, productivity suites can be accessed by mobile devices such as smartphones and tablet computers.

Through significant investment by service providers, the versatility and functionality of modern productivity suites has greatly expanded. For instance, modern list and/or spreadsheet software applications offer vastly increased variety and sophistication in functionality. While a list and/or spreadsheet can be used to simply store plaintext in a grid of cells the list and/or spreadsheet may also be required to perform calculations, support diverse data formats, and provide flexibility for data entry, organization, and analysis tasks.

However, while the utility of such software applications is helpful in accomplishing various tasks, users must consequently contend with increasing complexity often resulting in unwieldy and unengaging user experiences. For example, in some existing approaches, should the user wish to add new cells to a list, the user must individually create and format each addition. As such, adding even a few rows or columns can require dozens of separate inputs. Therefore, a user interface that enables a user to create and automatically format new cells can increase productivity, reduce erroneous inputs, and improve the user experience.

It is with respect to these and other considerations that the disclosure made herein is presented.

### SUMMARY

The disclosed techniques enhance the functionality of data entry software programs that display formattable tables, such as lists and spreadsheets. Generally described, a data entry software program can be a local program and/or a cloud service that is configured to receive data from a user through an input method (e.g., a keyboard, voice) and store the data in a computing system. In various examples, the data entry software program can utilize a user interface comprising a formattable table displaying a grid of cells which the user can manipulate to view and interact with data. Moreover, the data can be organized within a local and/or a cloud computing database depending on the use case. For instance, an offline spreadsheet program can store data locally while a cloud-based lists program can store data in a cloud computing database.

Typically, a data entry software program can enable a user to edit the grid of cells to suit their needs. For example, the user can add new rows and columns together to create a formattable table such as a list or a spreadsheet. In another example, the grid may be visually boundless to enable the user to freely expand the formattable table. In addition, the data entry program can support additional functionality beyond simply storing data. For instance, a column can be formatted to store a specific type of data (e.g., text, a date), perform calculations, and so forth.

However, as the functionality of data entry programs improves and expands, so to does the complexity of these programs. Consequently, user interfaces and data entry processes can become unwieldy, leading to a degraded user experience and reduced efficiency. For example, many existing approaches require a user to manually add and configure individual rows, columns, and even cells. As such, adding a few rows or columns can require dozens of separate inputs, in various user interfaces making for a cumbersome user experience. This inefficiency is further exacerbated for large data entry tasks (e.g., hundreds or rows and/or columns) leading to low productivity and increased risk for errors.

In contrast, the techniques of the present disclosure enable simultaneous row and column creation with a single input via a graphical preview. In various examples, the graphical preview can be summoned in response to a hover input through any suitable input method (e.g., a mouse, touch, stylus). As mentioned above, a data entry program can organize and present list data in a grid of cells in which an existing list can occupy a set of active cells. By placing a cursor at a desired position within the grid to perform the hover input, the user can define the number of cells they wish to add to a list. Stated another way, the position can be determined in relation to a position of the list to calculate the number of cells to be added.

In response to the hover input, the disclosed system can generate inactive placeholder cells based on the position of the hover input relative to the position of the list. The inactive placeholder cells can be unformatted cells within the grid that serve to earmark space in the data entry program for new cells. As will discussed below, the inactive placeholder cells can be distinct from active cells and inactive cells. In various examples, the inactive placeholder cells can be defined in a list data structure that is updated based on the position of the hover input. Moreover, active cells can be defined in a list schema that can track active cells and stored values.

Accordingly, a graphical preview of the inactive placeholder cells can be displayed within the grid alongside the existing list. Conversely, the user may create a new list in which case, the graphical preview can be displayed in an empty grid as no list currently exists. The system can subsequently receive a confirmation input at the position of the hover input which can cause the system to activate the inactive placeholder cells and append the newly active cells to the existing list. This update can occur within the list data structure mentioned above. The grid of cells can be accordingly updated to reflect the addition of new cells. New cells can be automatically configured with a default data format upon creation. Alternatively, the new cells may be custom formatted with an additional input.

The techniques discussed herein provide several technical benefits over existing methods for list management and formatting. As mentioned above, by implementing the disclosed system, data entry programs can dramatically streamline the user experience of creating and formatting new cells. Consequently, the disclosed system can reduce the time spent setting up a list leading to increased productivity and reduce the risk of operational errors.

In another example of the technical benefit of the present disclosure, the techniques discussed herein can improve the efficiency of cloud computing services as well. As discussed above, some data entry programs such as a local spreadsheet program can present a boundless grid of cells for a user to interact with. Conversely, a cloud-based lists program may limit the user to a grid of cells that the user has activated themselves. This can be due to a different set of constraints from a local spreadsheet program. For instance, available network bandwidth, computing resource usage, and other complex factors can impact the user experience of cloud-based programs. As such, the disclosed system can enable cloud-based lists programs to offer flexibility in list formatting without providing every user with a boundless grid of cells which can negatively impact computing resource usage.

Features and technical benefits other than those explicitly described above will be apparent from a reading of the following Detailed Description and a review of the associated drawings. This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter. The term “techniques,” for instance, may refer to system(s), method(s), computer-readable instructions, module(s), algorithms, hardware logic, and/or operation(s) as permitted by the context described above and throughout the document.

### BRIEF DESCRIPTION OF THE DRAWINGS

The Detailed Description is described with reference to the accompanying figures. In the figures, the left-most digit(s) of a reference number identifies the figure in which the reference number first appears. The same reference numbers in different figures indicate similar or identical items. References made to individual items of a plurality of items can use a reference number with a letter of a sequence of letters to refer to each individual item. Generic references to the items may use the specific reference number without the sequence of letters.

FIG. 1A illustrates an example user interface of a streamlined list formatting system in a first phase of an operation for adding new rows to an existing list.

FIG. 1B illustrates the example user interface of a streamlined list formatting system in a second phase of the operation for adding new rows to an existing list.

FIG. 1C illustrates the example user interface of a streamlined list formatting system in a third phase of the operation for adding new rows to an existing list.

FIG. 2A illustrates an example user interface of a streamlined list formatting system in a first phase of an operation for adding new columns to an existing list.

FIG. 2B illustrates the example user interface of a streamlined list formatting system in a second phase of the operation for adding new columns to an existing list.

FIG. 2C illustrates the example user interface of a streamlined list formatting system in an optional user interface for formatting new cells.

FIG. 3A illustrates an example user interface of a streamlined list formatting system in a first phase of an operation for adding new rows and columns to an existing list.

FIG. 3B illustrates an example user interface of a streamlined list formatting system in a second phase of the operation for adding new rows and columns to an existing list.

FIG. 4 is a block diagram of a system for enabling streamlined list formatting.

FIG. 5 is a flow diagram showing aspects of a routine for performing streamlined cell creation in a list using a hover input.

FIG. 6 is a computer architecture diagram illustrating an illustrative computer hardware and software architecture for a computing system capable of implementing aspects of the techniques and technologies presented herein.

FIG. 7 is a diagram illustrating a distributed computing environment capable of implementing aspects of the techniques and technologies presented herein.

### DETAILED DESCRIPTION

The techniques described herein enhance the operation of data entry programs by streamlining list creation and addition through a graphical preview of placeholder cells. For example, in a list comprising a grid of cells a user can place a cursor at a desired position relative to the position of the list to perform a hover input. In response, the disclosed system can generate a set of inactive placeholder cells based on the position of the hover input. In various examples, the inactive placeholder cells can be defined in a list data structure that is updated based on the position of the hover input.

A graphical preview of the inactive placeholder cells can accordingly be displayed within the grid of cells concurrently with the active cells of the existing list. As will be discussed below, the inactive placeholder cells of the graphical preview can be displayed in a different visual style to distinguish from active cells of the existing list. The system can subsequently receive a confirmation input to activate the inactive placeholder cells of the graphical preview. Accordingly, the inactive placeholder cells can be appended to the list and the grid can be updated to reflect the changed list with new cells added.

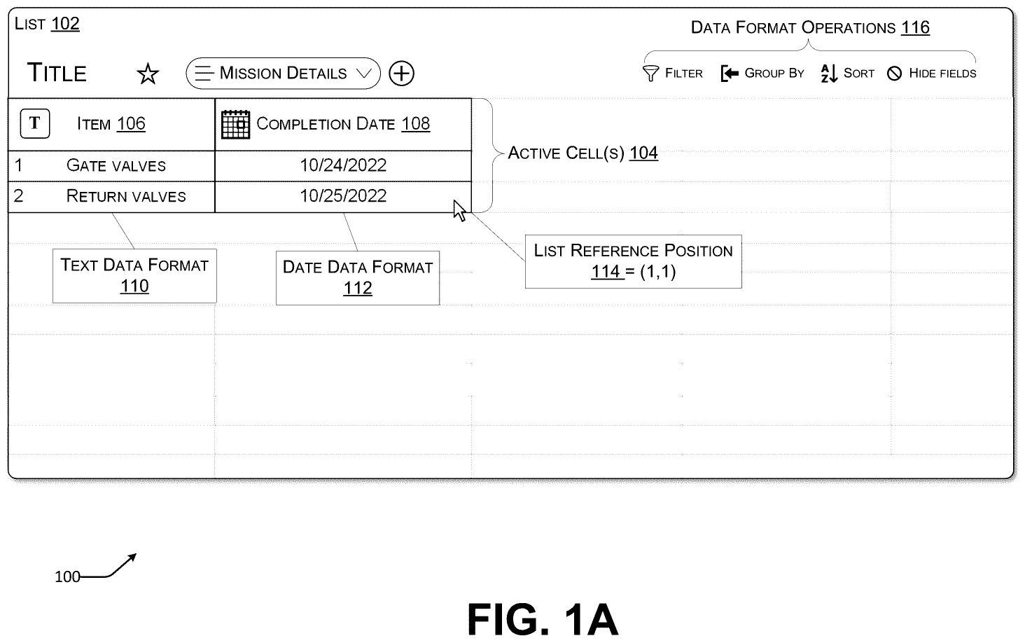

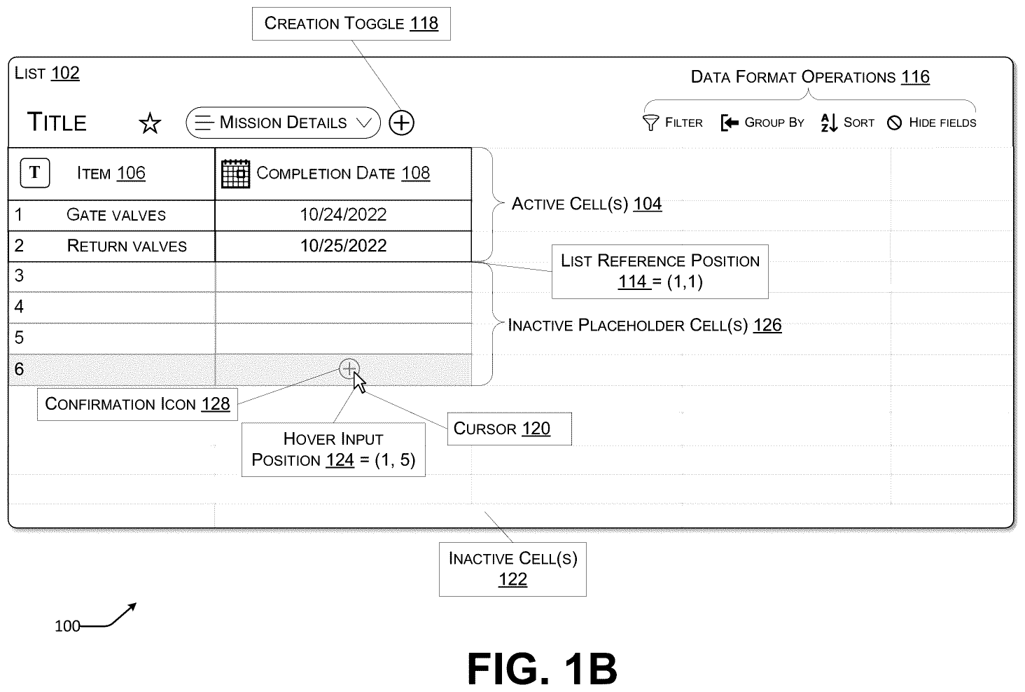

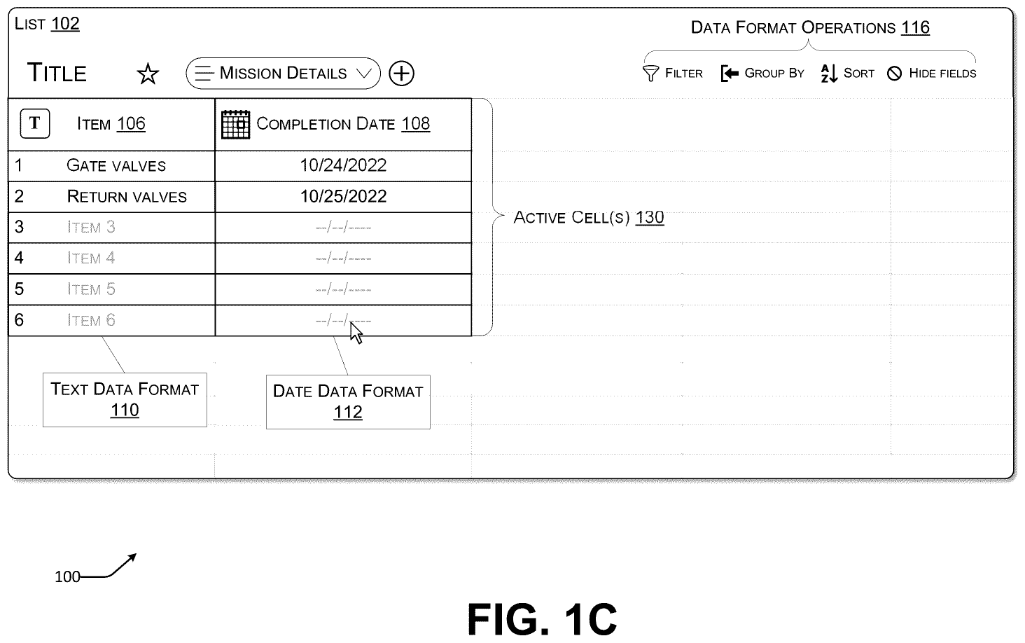

Various examples, scenarios, and aspects that enable streamlined cell creation and formatting in a data entry program are described below with respect to FIGS. 1-7. While FIGS. 1-7 illustrate formattable tables as lists, it is understood in the context of this disclosure that formattable tables can be a spreadsheets or other data entry interfaces.

FIG. 1 illustrates a user interface 100 of a list 102 comprising a grid of active cells 104. As shown, the list 102 can contain an “item” column 106 and a “completion date” column 108. The “item” column 106 can be configured with a text data format 110 to record text. In the present example, the “item” column 106 records the names of manufacturing objects. Similarly, the “completion date” column 108 can be configured with a date data format 112 to record a date. In various examples, cells within a single row can be associated with a single entity. For instance, row 1 in the list 102 states that the “gate valves” in the “item” column 106 are to be completed by “10/24/2022” as shown in the “completion date” column 108.

In addition, the list 102 can include a list reference position 114. The list reference position 114 can indicate the furthest extent of the grid of active cells 104. For the purposes of discussion, the list 102 can be understood to originate at the upper left corner of the grid. That is, the active cell 104 in first column of the first row can have a position of (0,0). As such, the list reference position 114 for the list 102 can be (1,1) indicating that the list 102 extends one column and one row from the origin at (0,0). Furthermore, the user interface 100 can also enable the user to operate on the list 102 in various ways using the data format operations 116. For instance, the active cells 104 can be filtered to display cells having a text data format 110 and not display those with a date data format 112.

Turning now to FIG. 1B, a user may wish to add more cells to the list 102. In various examples, the user can select a creation toggle 118 to initiate the cell creation process. By moving a cursor 120 into the field of inactive cells 122, the user can provide a hover input which can defines the number of cells to be created. For instance, the cursor 120 can be placed at the hover input position 124. In response, a set of inactive placeholder cells 126 can be generated and displayed alongside the active cells 104 within the grid of the list 102.

As mentioned above, the inactive placeholder cells 126 can be generated based on the hover input position 124 in relation to the list reference position 114. For example, as shown, the hover input position 124 can be defined as (1,5) indicating that the cursor 120 is one space away horizontally and five spaces away vertically from the origin at (0,0). In relation to the list reference position 114 at (1,1) the hover input position 124 is four spaces away vertically with no movement in the horizontal direction. Accordingly, four rows and zero columns of inactive placeholder cells 126 can be generated and displayed. Moreover, the inactive placeholder cells 126 can be shown in a shaded appearance to visually distinguish the inactive placeholder cells 126 from the active cells 104. In addition, a confirmation icon 128 can be displayed at the hover input position 124.

As shown in FIG. 1C, providing a confirmation input at the confirmation icon 128 can cause the inactive placeholder cells 126 to activate and be added to the list 102. Consequently, this results in a new grid of active cells 130. Furthermore, the newly added cells, being extensions of existing columns, can be automatically configured with the data format of that column. In the present example, new rows in the “item” column can be automatically configured with the text data format 110. Similarly, new rows of the “completion date” column 108 can be automatically configured with the date data format 112. In this way, new cells can be added to existing lists 102 and properly formatted with a single input. By reducing the number of inputs required to set up new cells, a user can accomplish tasks quicker and more efficiently.

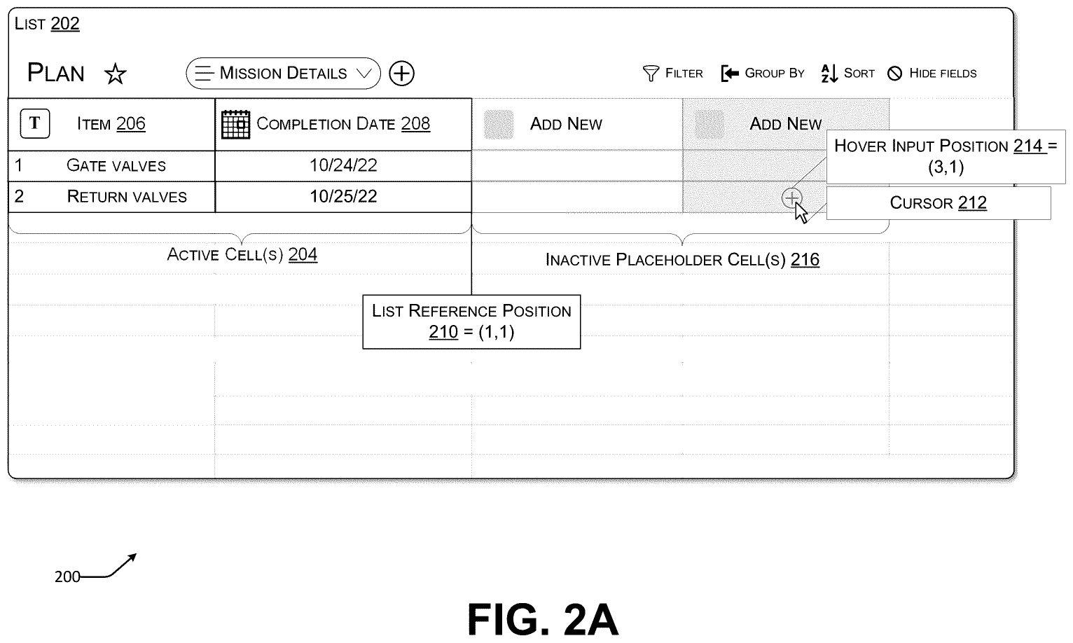

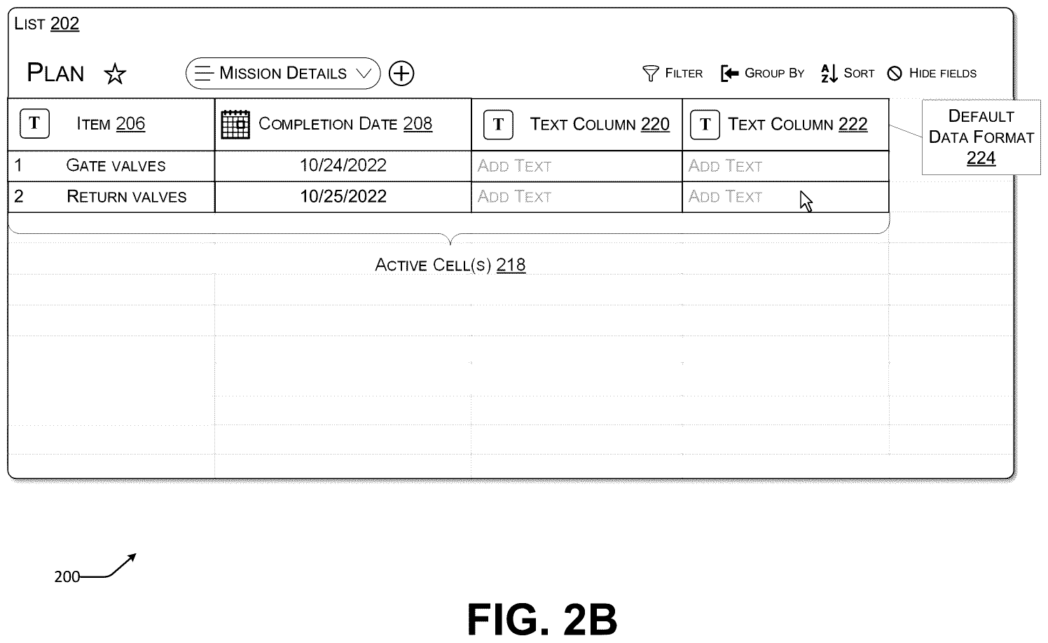

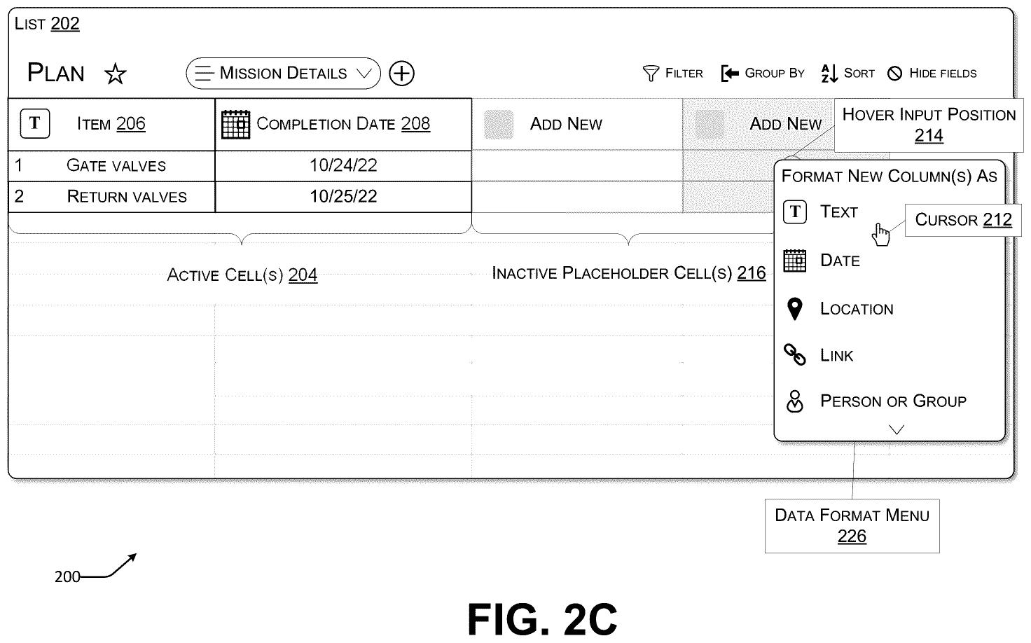

Turning now to FIG. 2A, another example of streamlined cell creation and formatting is shown and described. Like the above, examples, a user interface 200 can display a list 202 comprising a grid of active cells 204 comprising an “item” column 206 and a “completion date” column 208. This list 202 can also include a list reference position 210. Upon performing a hover input with a cursor 212 at a hover input position 214, a set of inactive placeholder cells 216 can be generated and displayed concurrently with the list 202 in response as shown by the shaded cells. As discussed above, the number of inactive placeholder cells 216 that are generated can be determined based on the hover input position 214 relative to the list reference position 210 at (1,1). In the present example, the hover input position 214 is two spaces away horizontally at (3,1) with no change in the vertical direction. As such, two new columns of inactive placeholder cells 216 can be generated with no additional rows created.

Proceeding to FIG. 2B, in response to a confirmation input at the hover input position 214, the inactive placeholder cells 216 can be activated and appended to the list to form an updated grid of active cells 218. As shown, the newly added columns 220 and 222 can be automatically configured with a default data format 224. In the present example, the default data format 224 can be a text data format. Unlike the examples discussed above, the newly added columns 220 and 222 in this scenario may not inherit a data format from an existing column as they are not extensions of existing columns. In various examples, the list 202 can be custom configured with a default data format 224 that suits the needs of various users. For instance, the default data format 224 can be changed to a numerical data format. Accordingly, all newly created columns can be automatically configured with the numerical data format by default.

Alternatively, as shown in FIG. 2C, newly added cells can be custom formatted prior to creation and addition to the list 202. For example, prior to receiving the confirmation input to activate the inactive placeholder cells 216, the system can instead receive an alternative input (e.g., a right click on a mouse) at the hover input position 214. In response, a data format menu 226 can be summoned to enable a user to configure the new cells with a data format of their choosing. For instance, while the default data format 224 discussed above may be a text data format, new cells can be optionally configured as a location data format without modifying the default data format 224. Upon selection of a data format from the data format menu 226, the inactive placeholder cells 216 can be activated and appended to the grid of active cells 204 in the list 202.

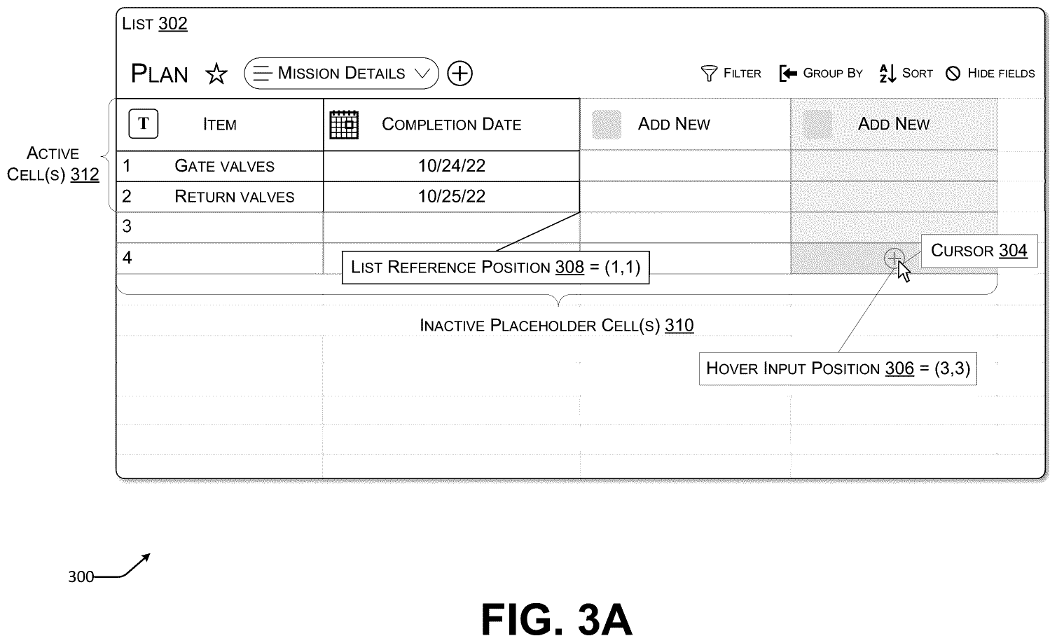

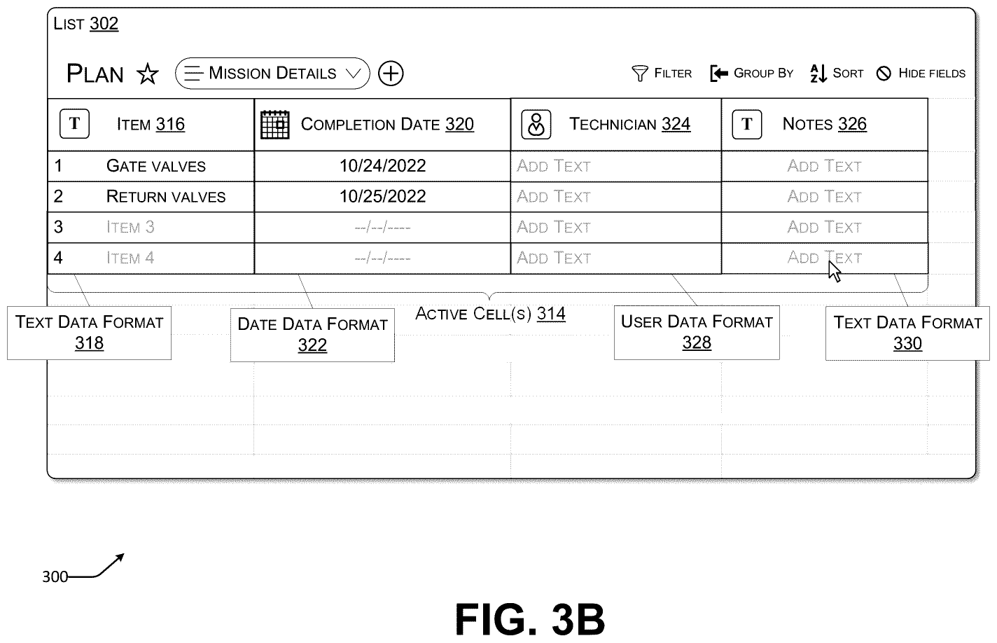

Turning now to FIG. 3A, aspects of a third example user interface 300 for interacting with a list 302 are shown and described. The examples discussed above with respect to FIGS. 1A-1C relate to adding new rows to a list 102 while the examples discussed with respect to FIGS. 2A-2C relate to adding new columns to a list 202. As shown, beyond adding just rows or just columns, a cursor 304 can be positioned to add new cells in both rows and columns to an existing list 302. Similar to the above examples, the number of new cells to be added can be determined based on a hover input position 306 relative to a list reference position 308. For example, hover input position 306 in the present example is at (3,3) indicating that the hover input position is two spaces away vertically and two spaces away horizontally from the list reference position 308 at (1,1). Accordingly, a set of inactive placeholder cells 310 can be generated and displayed concurrently with the grid of active cells 312 within the list 302.

Subsequently, as shown in FIG. 3B, the user interface 300 can receive a confirmation input at the hover input position 306 to activate the inactive placeholder cells 310 to generate a new grid of active cells 314. As discussed above, rows that are added to existing columns can inherit the data format of the existing columns. For example, new rows added to the “item” column 316 can be automatically configured with a text data format 318. Similarly, new rows of the “completion date” column 320 can be automatically configured with the date data format 322.

In addition, new columns such as the “technician” column 324 and the “notes” column 326 can also be automatically configured with data formats. While the “technician” column 324 and the “notes” column 326 may be configured with a default data format as discussed above, the list 302 can also be configured with various settings that dictate the data format of new columns such as a template or a predictive model. In a specific example, the list 302 can be configured with a template for tracking manufacturing work tasks for a group of people. Accordingly, a first newly created column 324 can be automatically configured as a “technician” column 324 with a user data format 328 for tracking a person that is responsible for an associated item in the “item” column 316. Similarly, a second newly created column 326 can automatically configured as a “notes” column 326 with a text data format 330 for storing miscellaneous notes regarding an associated item in the “item” column 316. As mentioned above, cells within a row can be understood as all relating to a particular entity (e.g., an item).

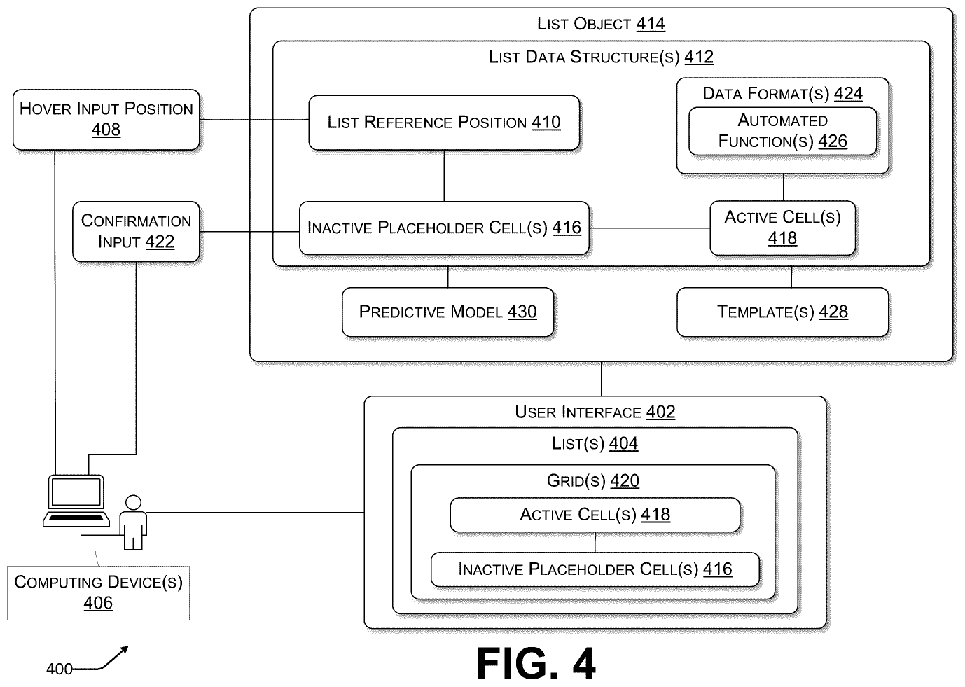

Proceeding now to FIG. 4, aspects of a system 400 of a data entry program for enabling streamlined cell creation and list formatting as shown and discussed in the examples above. In various examples, a user can interact with a user interface 402 displaying a list 404 via a computing device 406 (e.g., a laptop, a tablet). The user can accordingly provide a hover input at a hover input position 408 that can be compared against a list reference position 410 within a list data structure 412 of a list object 414. The results of this comparison can be used by the system 400 to generate a set of inactive placeholder cells 416. As mentioned above, the number of inactive placeholder cells 416 that are generated can be determined based on the difference between the hover input position 408 and the list reference position 410. The user interface 402 can be accordingly updated to display the inactive placeholder cells 416 concurrently with active cells 418 in a grid 420. In addition, list data structure 412 and the grid 420 can be continuously updated as the hover input position 408 changes.

The user can subsequently provide a confirmation input 422 that causes an update to the list data structure 412 to activate the inactive placeholder cells 416 and append them to the active cells 418. In addition, the list data structure 412 can configure newly created active cells 418 with data formats 424 that enable an active cell 418 to store an associated data type such as the text data format discussed above. In addition, a data format 424 can include various automated functions 426 based on a data type of the data format 424. For example, a date data format can include an automated function 426 that generates a reminder notification when a target date is near (e.g., a week beforehand). In a specific example, consider a “completion date” column discussed above.

An automated function 426 of the “completion date” column can cause the system 400 to generate an email reminder to alert a user that a completion date is near.

In another example, cells of differing data formats 424 within a single row can interact together to implement an automated function 426. For example, consider the “item” column 316, “completion date” column 320, and “technician” column 324 discussed above with respect to FIGS. 3A and 3B. In this example, the system 400 can generate a reminder prior to the completion date in the “completion date” column 320 regarding an associated item in the “item” column 316 that is sent to an associated user in the “technician” column 324. Moreover, a single data format 424 can define multiple associated automated functions 426. For instance, a user data format can execute a first automated function 426 that sends an email to an associated user while a second automated function 426 sends the associated user a text message.

The list object 414 can be further configured with a template 428 and/or a predictive model 430 for automatically formatting newly created active cells 418. For example, a template 428 can dictate which data format 424 a new active cell 418 is configured with. When a template 428 is in use, data formats 424 selected by the template can supersede any default data format. For instance, the list object 414 may be configured with a default text data format. If the template 428 defines a date data format, the date data format can override the default text data format. Furthermore, if the template 428 does not define a data format 424 for a new active cell 418 (e.g., a list object 414 extending beyond the definitions of the template 428) the default data format can be accordingly applied.

Alternatively, a predictive model 430 can replace and/or augment a template 428 for assigning data formats 424 to newly created active cells 418. In various examples, the predictive model 430 can be a machine learning model or other artificial intelligence program that can analyze trends within the list data structure 412. Accordingly, the predictive model 430 can select a data format 424 to configure a new active cell 418 based on the data formats 424 of previously created active cells 418. For example, if the list data structure 412 contains many predominantly active cells 418 that are configured with a user data format, the predictive model 430 can select a user data format in kind. Conversely, the predictive model 430 can select a complimentary data format 424 for new active cells. In this way, a predictive model 430 can further streamline the process of setting up and formatting a list 404.

Once the inactive placeholder cells 416 are activated and appended to the active cells 418, the user interface 402 can be updated to reflect the changes. As discussed above, the inactive placeholder cells 416 can be displayed in a visually distinct manner from the active cells 418 for previewing purposes. Following the activation via the confirmation input 422, the inactive placeholder cells 416 can transition to active cells 418. This transition can be visually communicated as the inactive placeholder cells 416 take on the visual style of the active cells 418 within the grid 420 of the user interface to reflect the changed plurality of active cells 418.

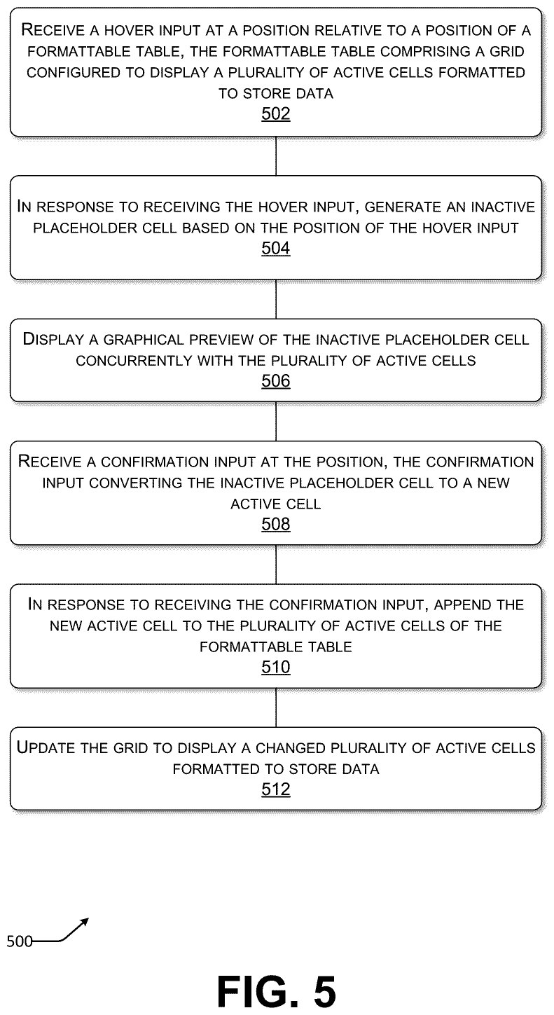

Proceeding to FIG. 5, aspects of a routine 500 for performing streamlined cell creation and formatting in a list are shown and described. With reference to FIG. 5, the routine 500 begins at operation 502 where a system receives a hover input at a position relative to a reference position of a formattable table. As described above, the formattable table includes a grid configured to display a plurality of cells formatted to store data. In various examples, the formattable table can be a list, a spreadsheet, and so forth.

Next, at operation 504, in response to receiving the hover input, the system generates an inactive placeholder cell based on the position of the hover input.

Then, at operation 506, the system displays a graphical preview of the inactive placeholder cell concurrently with the plurality of active cells.

Subsequently, at operation 508, the system receives a confirmation input at the position, the confirmation input converting the inactive placeholder cell to a new active cell.

Next, at operation 510, in response to receiving the confirmation input, the system appends the new active cell to the plurality of active cells of the formattable table.

Finally, at operation 512, the system updates the grid to display a changed plurality of active cells formatted to store data.

For ease of understanding, the processes discussed in this disclosure are delineated as separate operations represented as independent blocks. However, these separately delineated operations should not be construed as necessarily order dependent in their performance. The order in which the process is described is not intended to be construed as a limitation, and any number of the described process blocks may be combined in any order to implement the process or an alternate process. Moreover, it is also possible that one or more of the provided operations is modified or omitted.

The particular implementation of the technologies disclosed herein is a matter of choice dependent on the performance and other requirements of a computing device. Accordingly, the logical operations described herein are referred to variously as states, operations, structural devices, acts, or modules. These states, operations, structural devices, acts, and modules can be implemented in hardware, software, firmware, in special-purpose digital logic, and any combination thereof. It should be appreciated that more or fewer operations can be performed than shown in the figures and described herein. These operations can also be performed in a different order than those described herein.

It also should be understood that the illustrated methods can end at any time and need not be performed in their entireties. Some or all operations of the methods, and/or substantially equivalent operations, can be performed by execution of computer-readable instructions included on a computer-storage media, as defined below. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These operations, structural devices, acts, and modules may be implemented in software, in firmware, in special purpose digital logic, and any combination thereof.

For example, the operations of the routine 500 can be implemented, at least in part, by modules running the features disclosed herein can be a dynamically linked library (DLL), a statically linked library, functionality produced by an application programing interface (API), a compiled program, an interpreted program, a script, or any other executable set of instructions. Data can be stored in a data structure in one or more memory components. Data can be retrieved from the data structure by addressing links or references to the data structure.

Although the illustration may refer to the components of the figures, it should be appreciated that the operations of the routine 500 may be also implemented in other ways. In addition, one or more of the operations of the routine 500 may alternatively or additionally be implemented, at least in part, by a chipset working alone or in conjunction with other software modules. In the example described below, one or more modules of a computing system can receive and/or process the data disclosed herein. Any service, circuit, or application suitable for providing the techniques disclosed herein can be used in operations described herein.

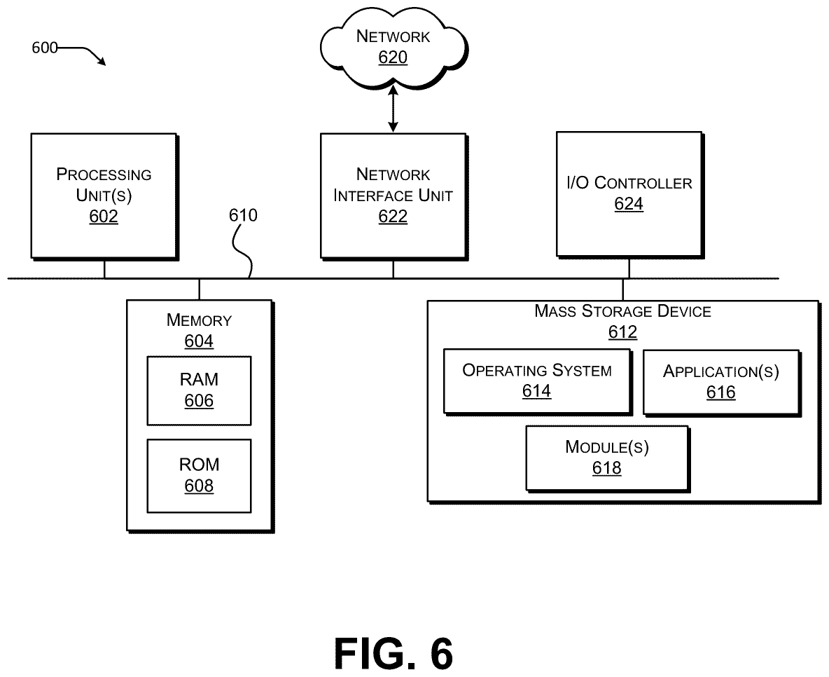

FIG. 6 shows additional details of an example computer architecture 600 for a device, such as a computer or a server configured as part of the cloud-based platform or system 100, capable of executing computer instructions (e.g., a module or a program component described herein). The computer architecture 600 illustrated in FIG. 6 includes processing system 602, a system memory 604, including a random-access memory 606 (RAM) and a read-only memory (ROM) 608, and a system bus 610 that couples the memory 604 to the processing system 602. The processing system 602 comprises processing unit(s). In various examples, the processing unit(s) of the processing system 602 are distributed. Stated another way, one processing unit of the processing system 602 may be located in a first location (e.g., a rack within a datacenter) while another processing unit of the processing system 602 is located in a second location separate from the first location.

Processing unit(s), such as processing unit(s) of processing system 602, can represent, for example, a CPU-type processing unit, a GPU-type processing unit, a field-programmable gate array (FPGA), another class of digital signal processor (DSP), or other hardware logic components that may, in some instances, be driven by a CPU. For example, illustrative types of hardware logic components that can be used include Application-Specific Integrated Circuits (ASICs), Application-Specific Standard Products (ASSPs), System-on-a-Chip Systems (SOCs), Complex Programmable Logic Devices (CPLDs), and the like.

A basic input/output system containing the basic routines that help to transfer information between elements within the computer architecture 600, such as during startup, is stored in the ROM 608. The computer architecture 600 further includes a mass storage device 612 for storing an operating system 614, application(s) 616, modules 618, and other data described herein.

The mass storage device 612 is connected to processing system 602 through a mass storage controller connected to the bus 610. The mass storage device 612 and its associated computer-readable media provide non-volatile storage for the computer architecture 600. Although the description of computer-readable media contained herein refers to a mass storage device, the computer-readable media can be any available computer-readable storage media or communication media that can be accessed by the computer architecture 600.

Computer-readable media includes computer-readable storage media and/or communication media. Computer-readable storage media includes one or more of volatile memory, nonvolatile memory, and/or other persistent and/or auxiliary computer storage media, removable and non-removable computer storage media implemented in any method or technology for storage of information such as computer-readable instructions, data structures, program modules, or other data. Thus, computer storage media includes tangible and/or physical forms of media included in a device and/or hardware component that is part of a device or external to a device, including RAM, static RAM (SRAM), dynamic RAM (DRAM), phase change memory (PCM), ROM, erasable programmable ROM (EPROM), electrically EPROM (EEPROM), flash memory, compact disc read-only memory (CD-ROM), digital versatile disks (DVDs), optical cards or other optical storage media, magnetic cassettes, magnetic tape, magnetic disk storage, magnetic cards or other magnetic storage devices or media, solid-state memory devices, storage arrays, network attached storage, storage area networks, hosted computer storage or any other storage memory, storage device, and/or storage medium that can be used to store and maintain information for access by a computing device.

In contrast to computer-readable storage media, communication media can embody computer-readable instructions, data structures, program modules, or other data in a modulated data signal, such as a carrier wave, or other transmission mechanism. As defined herein, computer storage media does not include communication media. That is, computer-readable storage media does not include communications media consisting solely of a modulated data signal, a carrier wave, or a propagated signal, per se.

According to various configurations, the computer architecture 600 may operate in a networked environment using logical connections to remote computers through the network 620. The computer architecture 600 may connect to the network 620 through a network interface unit 622 connected to the bus 610. The computer architecture 600 also may include an input/output controller 624 for receiving and processing input from a number of other devices, including a keyboard, mouse, touch, or electronic stylus or pen. Similarly, the input/output controller 624 may provide output to a display screen, a printer, or other type of output device.

The software components described herein may, when loaded into the processing system 602 and executed, transform the processing system 602 and the overall computer architecture 600 from a general-purpose computing system into a special-purpose computing system customized to facilitate the functionality presented herein. The processing system 602 may be constructed from any number of transistors or other discrete circuit elements, which may individually or collectively assume any number of states. More specifically, the processing system 602 may operate as a finite-state machine, in response to executable instructions contained within the software modules disclosed herein. These computer-executable instructions may transform the processing system 602 by specifying how the processing system 602 transition between states, thereby transforming the transistors or other discrete hardware elements constituting the processing system 602.

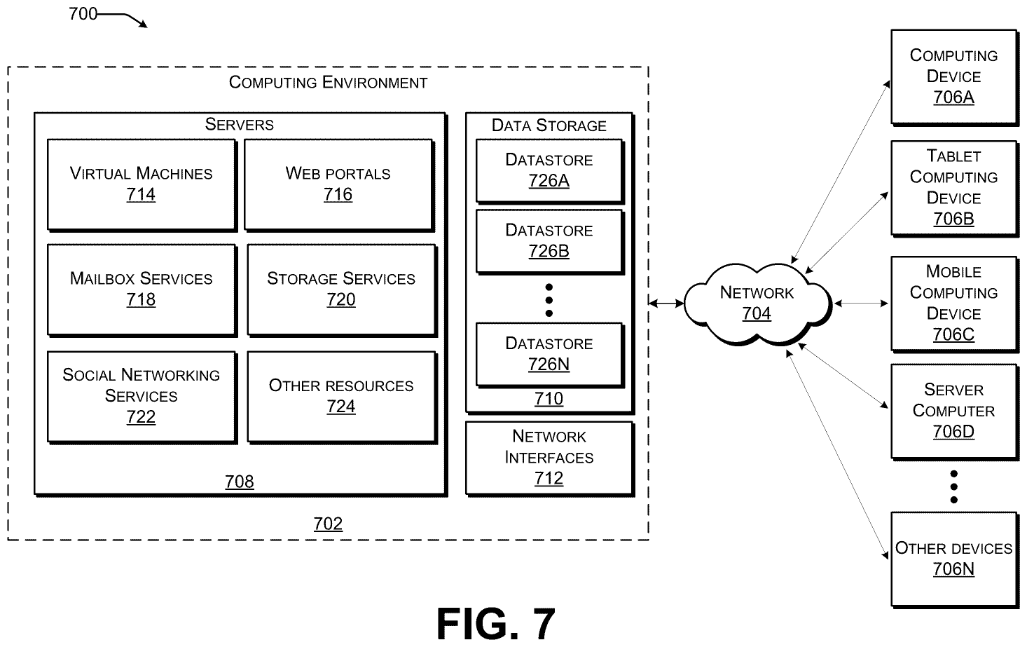

FIG. 7 depicts an illustrative distributed computing environment 700 capable of executing the software components described herein. Thus, the distributed computing environment 700 illustrated in FIG. 7 can be utilized to execute any aspects of the software components presented herein. For example, the distributed computing environment 700 can be utilized to execute aspects of the software components described herein.

Accordingly, the distributed computing environment 700 can include a computing environment 702 operating on, in communication with, or as part of the network 704. The network 704 can include various access networks. One or more client devices 706A-706N (hereinafter referred to collectively and/or generically as “computing devices 706”) can communicate with the computing environment 702 via the network 704. In one illustrated configuration, the computing devices 706 include a computing device 706A such as a laptop computer, a desktop computer, or other computing device; a slate or tablet computing device (“tablet computing device”) 706B; a mobile computing device 706C such as a mobile telephone, a smart phone, or other mobile computing device; a server computer 706D; and/or other devices 706N. It should be understood that any number of computing devices 706 can communicate with the computing environment 702.

In various examples, the computing environment 702 includes servers 708, data storage 610, and one or more network interfaces 712. The servers 708 can host various services, virtual machines, portals, and/or other resources. In the illustrated configuration, the servers 708 host virtual machines 714, Web portals 716, mailbox services 718, storage services 720, and/or social networking services 722. As shown in FIG. 7 the servers 708 also can host other services, applications, portals, and/or other resources (“other resources”) 724.

As mentioned above, the computing environment 702 can include the data storage 710. According to various implementations, the functionality of the data storage 710 is provided by one or more databases operating on, or in communication with, the network 704. The functionality of the data storage 710 also can be provided by one or more servers configured to host data for the computing environment 700. The data storage 710 can include, host, or provide one or more real or virtual datastores 726A-726N (hereinafter referred to collectively and/or generically as “datastores 726”). The datastores 726 are configured to host data used or created by the servers 808 and/or other data. That is, the datastores 726 also can host or store web page documents, word documents, presentation documents, data structures, algorithms for execution by a recommendation engine, and/or other data utilized by any application program. Aspects of the datastores 726 may be associated with a service for storing files.

The computing environment 702 can communicate with, or be accessed by, the network interfaces 712. The network interfaces 712 can include various types of network hardware and software for supporting communications between two or more computing devices including the computing devices and the servers. It should be appreciated that the network interfaces 712 also may be utilized to connect to other types of networks and/or computer systems.

The disclosure presented herein also encompasses the subject matter set forth in the following clauses.

Example Clause A, a method comprising: receiving a hover input at a position relative to a position of a formattable table, the formattable table comprising a grid configured to display a plurality of active cells formatted to store data; in response to receiving the hover input, generating an inactive placeholder cell based on the position of the hover input; displaying a graphical preview of the inactive placeholder cell concurrently with the plurality of active cells; receiving a confirmation input at the position, the confirmation input converting the inactive placeholder cell to a new active cell; in response to receiving the confirmation input, appending the new active cell to the plurality of active cells of the formattable table; and updating the grid to display a changed plurality of active cells formatted to store data.

Example Clause B, the method of Example Clause A, wherein: the position relative to the position of the formattable table is a horizontal position; and the inactive placeholder cell is a column.

Example Clause C, the method of Example Clause A, wherein: the position relative to the position of the formattable table is a vertical position; and the inactive placeholder cell is a row.

Example Clause D, the method of any one of Example Clause A through C, wherein the new active cell includes a default data format configured to store text data.

Example Clause E, the method of any one of Example Clause A through D, wherein the new active cell includes a data format defining an automated function.

Example Clause F, the method of any one of Example Clause A through E, wherein the formattable table is formatted based on a predefined template, wherein the predefined template defines a data type for a column of the formattable table.

Example Clause G, the method of any one of Example Clause A through F, wherein the new active cell is automatically configured with a data format based on a current data format of the formattable table.

Example Clause H, a system comprising: a processing unit; a computer-readable medium having encoded thereon computer-readable instructions that, when executed by the processing unit, cause the system to: receive a hover input at a position relative to a position of a formattable table, the formattable table comprising a grid configured to display a plurality of active cells formatted to store data; in response to receiving the hover input, generate an inactive placeholder cell based on the position of the hover input; display a graphical preview of the inactive placeholder cell concurrently with the plurality of active cells; receive a confirmation input at the position, the confirmation input converting the inactive placeholder cell to a new active cell; in response to receiving the confirmation input, append the new active cell to the plurality of active cells of the formattable table; and update the grid to display a changed plurality of active cells formatted to store data.

Example Clause I, the system of Example Clause H, wherein: the position relative to the position of the formattable table is a horizontal position; and the inactive placeholder cell is a column.

Example Clause J, the system of Example Clause H, wherein: the position relative to the position of the formattable table is a vertical position; and the inactive placeholder cell is a row.

Example Clause K, the system of any one of Example Clause H through J, wherein the new active cell includes a default data format configured to store text data.

Example Clause L, the system of any one of Example Clause H through K, wherein the new active cell includes a data format defining an automated function.

Example Clause M, the system of any one of Example Clause H through L, wherein the formattable table is formatted based on a predefined template, wherein the predefined template defines a data type for a column of the formattable table.

Example Clause N, the system of any one of Example Clause H through M, wherein the new active cell is automatically configured with a data format based on a current data format of the formattable table.

Example Clause O, a computer-readable storage medium having encoded thereon computer-readable instructions that, when executed by a system, cause the system to: receive a hover input at a position relative to a position of a formattable table, the formattable table comprising a grid configured to display a plurality of active cells formatted to store data; in response to receiving the hover input, generate an inactive placeholder cell based on the position of the hover input; display a graphical preview of the inactive placeholder cell concurrently with the plurality of active cells; receive a confirmation input at the position, the confirmation input converting the inactive placeholder cell to a new active cell; in response to receiving the confirmation input, append the new active cell to the plurality of active cells of the formattable table; and update the grid to display a changed plurality of active cells formatted to store data.

Example Clause P, the computer-readable storage medium of Example Clause O, wherein: the position relative to the position of the formattable table is a horizontal position; and the inactive placeholder cell is a column.

Example Clause Q, the computer-readable storage medium of Example Clause O, wherein: the position relative to the position of the formattable table is a vertical position; and the inactive placeholder cell is a row.

Example Clause R, the computer-readable storage medium of any one of Example Clause O through Q, wherein the new active cell includes a default data format configured to store text data.

Example Clause S, the computer-readable storage medium of any one of Example Clause O through R, wherein the new active cell includes a data format defining an automated function.

Example Clause T, the computer-readable storage medium of any one of Example Clause O through S, wherein the formattable table is formatted based on a predefined template, wherein the predefined template defines a data type for a column of the formattable table.

It should be understood that the distributed computing environment 700 described herein can provide any aspects of the software elements described herein with any number of virtual computing resources and/or other distributed computing functionality that can be configured to execute any aspects of the software components disclosed herein. According to various implementations of the concepts and technologies disclosed herein, the distributed computing environment 700 provides the software functionality described herein as a service to the computing devices. It should be understood that the computing devices can include real or virtual machines including server computers, web servers, personal computers, mobile computing devices, smart phones, and/or other devices. As such, various configurations of the concepts and technologies disclosed herein enable any device configured to access the distributed computing environment 700 to utilize the functionality described herein for providing the techniques disclosed herein, among other aspects.

Conditional language such as, among others, “can,” “could,” “might” or “may,” unless specifically stated otherwise, are understood within the context to present that certain examples include, while other examples do not include, certain features, elements and/or steps. Thus, such conditional language is not generally intended to imply that certain features, elements and/or steps are in any way required for one or more examples or that one or more examples necessarily include logic for deciding, with or without user input or prompting, whether certain features, elements and/or steps are included or are to be performed in any particular example. Conjunctive language such as the phrase “at least one of X, Y or Z,” unless specifically stated otherwise, is to be understood to present that an item, term, etc. may be either X, Y, or Z, or a combination thereof.

The terms “a,” “an,” “the” and similar referents used in the context of describing the invention (especially in the context of the following claims) are to be construed to cover both the singular and the plural unless otherwise indicated herein or clearly contradicted by context. The terms “based on,” “based upon,” and similar referents are to be construed as meaning “based at least in part” which includes being “based in part” and “based in whole” unless otherwise indicated or clearly contradicted by context.

In addition, any reference to “first,” “second,” etc. elements within the Summary and/or Detailed Description is not intended to and should not be construed to necessarily correspond to any reference of “first,” “second,” etc. elements of the claims. Rather, any use of “first” and “second” within the Summary, Detailed Description, and/or claims may be used to distinguish between two different instances of the same element (e.g., two different cells).

In closing, although the various configurations have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

1. A method comprising:
receiving a hover input at a position relative to a position of a formattable table, the formattable table comprising a grid configured to display a plurality of active cells formatted to store data;
in response to receiving the hover input, generating an inactive placeholder cell based on the position of the hover input;
displaying a graphical preview of the inactive placeholder cell concurrently with the plurality of active cells;
receiving a confirmation input at the position, the confirmation input converting the inactive placeholder cell to a new active cell;
in response to receiving the confirmation input, appending the new active cell to the plurality of active cells of the formattable table; and
updating the grid to display a changed plurality of active cells formatted to store data.

2. The method of claim 1, wherein:
the position relative to the position of the formattable table is a horizontal position; and
the inactive placeholder cell is a column.

3. The method of claim 1, wherein:
the position relative to the position of the formattable table is a vertical position; and
the inactive placeholder cell is a row.

4. The method of claim 1, wherein the new active cell includes a default data format configured to store text data.

5. The method of claim 1, wherein the new active cell includes a data format defining an automated function.

6. The method of claim 1, wherein the formattable table is formatted based on a predefined template, wherein the predefined template defines a data type for a column of the formattable table.

7. The method of claim 1, wherein the new active cell is automatically configured with a data format based on a current data format of the formattable table.

8. A system comprising:
a processing unit;
a computer-readable medium having encoded thereon computer-readable instructions that, when executed by the processing unit, cause the system to:
receive a hover input at a position relative to a position of a formattable table, the formattable table comprising a grid configured to display a plurality of active cells formatted to store data;
in response to receiving the hover input, generate an inactive placeholder cell based on the position of the hover input;
display a graphical preview of the inactive placeholder cell concurrently with the plurality of active cells;
receive a confirmation input at the position, the confirmation input converting the inactive placeholder cell to a new active cell;
in response to receiving the confirmation input, append the new active cell to the plurality of active cells of the formattable table; and
update the grid to display a changed plurality of active cells formatted to store data.

9. The system of claim 8, wherein:
the position relative to the position of the formattable table is a horizontal position; and
the inactive placeholder cell is a column.

10. The system of claim 8, wherein:
the position relative to the position of the formattable table is a vertical position; and
the inactive placeholder cell is a row.

11. The system of claim 8, wherein the new active cell includes a default data format configured to store text data.

12. The system of claim 8, wherein the new active cell includes a data format defining an automated function.

13. The system of claim 8, wherein the formattable table is formatted based on a predefined template, wherein the predefined template defines a data type for a column of the formattable table.

14. The system of claim 8, wherein the new active cell is automatically configured with a data format based on a current data format of the formattable table.

15. A computer-readable storage medium having encoded thereon computer-readable instructions that, when executed by a system, cause the system to:
receive a hover input at a position relative to a position of a formattable table, the formattable table comprising a grid configured to display a plurality of active cells formatted to store data;
in response to receiving the hover input, generate an inactive placeholder cell based on the position of the hover input;
display a graphical preview of the inactive placeholder cell concurrently with the plurality of active cells;
receive a confirmation input at the position, the confirmation input converting the inactive placeholder cell to a new active cell;
in response to receiving the confirmation input, append the new active cell to the plurality of active cells of the formattable table; and
update the grid to display a changed plurality of active cells formatted to store data.

16. The computer-readable storage medium of claim 15, wherein: the position relative to the position of the formattable table is a horizontal position; and
the inactive placeholder cell is a column.

17. The computer-readable storage medium of claim 15, wherein:
the position relative to the position of the formattable table is a vertical position; and
the inactive placeholder cell is a row.

18. The computer-readable storage medium of claim 15, wherein the new active cell includes a default data format configured to store text data.

19. The computer-readable storage medium of claim 15, wherein the new active cell includes a data format defining an automated function.

20. The computer-readable storage medium of claim 15, wherein the formattable table is formatted based on a predefined template, wherein the predefined template defines a data type for a column of the formattable table.
